(19) United States
(12) Patent Application Publication
(10) Pub. No.: US 2008/0043885 A1
(43) Pub. Date: Feb. 21, 2008

(54) Complex Correlator for a Vestigial Sideband Modulated System

(76) Inventor: Ivonete Markman, Carmel, IN (US)

Correspondence Address: THOMSON LICENSING LLC, Two Independence Way, Suite 200, PRINCETON, NJ, 08540, US

(21) Appl. No.: 11/596,339

(22) PCT Filed: Mar. 29, 2005
(86) PCT No.: PCT/US05/10503

§ 371 Date: Nov. 9, 2006

Related U.S. Application Data
(60) Provisional application No. 60/570,413, filed on May 12, 2004.
(60) Provisional application No. 60/570,295, filed on May 12, 2004.

(51) Int. Cl. H04L 27/06

(52) U.S. Cl. 375/343; 375/340; 375/E01.001

(57) ABSTRACT

A receiver comprises a demodulator and a complex correlator. The demodulator demodulates a received signal and provides a demodulated signal. The complex correlator correlates an in-phase component of the demodulated signal against a data pattern and correlates a quadrature component of the demodulated signal against a Hilbert transform of the data pattern.

### BACKGROUND OF THE INVENTION

The present invention generally relates to communications systems and, more particularly, to a receiver.

In modern digital communication systems like the ATSC-DTV (Advanced Television Systems Committee-Digital Television) system (e.g., see, United States Advanced Television Systems Committee, “ATSC Digital Television Standard”, Document A/53, Sep. 16, 1995 and “Guide to the Use of the ATSC Digital Television Standard”, Document A/54, Oct. 4, 1995), advanced modulation, channel coding and equalization are usually applied. In the receiver, demodulators generally have carrier phase and/or symbol timing ambiguity. Equalizers are generally a DFE (Decision Feedback Equalizer) type or some variation of it and have a finite length. In severely distorted channels, it is important to know the virtual center of the channel impulse response to give the equalizer the best chance of successfully processing the signal and correcting for distortion. One approach is to use a centroid calculator that calculates the channel virtual center for an adaptive equalizer based on a segment synchronization (sync) signal. Another approach is to use a centroid calculator that calculates the channel virtual center for an adaptive equalizer based on a frame sync signal.

In this regard, detection of a received VSB sync, or training, signal typically employs the use of a real correlator, which compares the in-phase portion of the received signal against the known training, or sync, pattern.

### SUMMARY OF THE INVENTION

We have realized that use of a real correlator in a receiver may limit receiver performance since the real correlator only uses the in-phase component of the received signal. Therefore, and in accordance with the principles of the invention, a receiver comprises a demodulator for providing a demodulated signal and a complex correlator for correlating the demodulated signal against a data pattern.

In an embodiment of the invention, an ATSC receiver comprises a demodulator and a complex correlator. The demodulator demodulates a received ATSC-DTV signal and provides a demodulated signal. The complex correlator correlates an in-phase component of the demodulated signal against the ATSC segment sync pattern and correlates a quadrature component of the demodulated signal against a Hilbert transform of the ATSC segment sync pattern.

In another embodiment of the invention, an ATSC receiver comprises a demodulator and a complex correlator. The demodulator demodulates a received ATSC-DTV signal and provides a demodulated signal. The complex correlator correlates a quadrature component of the demodulated signal against the ATSC segment sync pattern and correlates an in-phase component of the demodulated signal against a Hilbert transform of the ATSC segment sync pattern.

In another embodiment of the invention, an ATSC receiver comprises a demodulator and a centroid calculator that includes a complex correlator. The demodulator demodulates a received ATSC-DTV signal and provides a demodulated signal. The centroid calculator processes the demodulated signal to determine a channel virtual center for use in, e.g., an adaptive equalizer. The use of the complex correlator in the centroid calculator results in the centroid calculator being immune to symbol timing phase ambiguity in the demodulated signal.

In accordance with a feature of the invention, the above-described centroid calculator comprises an internal limiter, which improves performance.

### BRIEF DESCRIPTION OF THE DRAWINGS

FIG. 1 shows a prior art ATSC-DTV Vestigial Sideband (VSB) data framing structure;

FIG. 2 shows a prior art ATSC-DTV field sync structure;

FIG. 3 shows a prior art ATSC-DTV segment sync detector;

FIG. 4 shows Table One;

FIG. 5 shows an illustrative high-level block diagram of a receiver embodying the principles of the invention;

FIGS. 6 and 7 show illustrative portions of a receiver embodying the principles of the invention;

FIG. 8 shows an illustrative embodiment of a complex correlator in accordance with the principles of the invention;

FIG. 9 shows Table Two;

FIG. 10 shows another illustrative embodiment of a complex correlator in accordance with the principles of the invention;

FIG. 11 shows Table Three;

FIG. 12 shows an illustrative flow chart in accordance with the principles of the invention;

FIG. 13 shows a block diagram of a prior art centroid calculator;

FIG. 14 shows a block diagram for processing a complex signal for use in a complex centroid calculator;

FIG. 15 shows an illustrative embodiment of a centroid calculator in accordance with the principles of the invention;

FIG. 16 shows another illustrative embodiment of a portion of a centroid calculator in accordance with the principles of the invention;

FIG. 17 shows another illustrative embodiment of a centroid calculator in accordance with the principles of the invention;

FIG. 18 shows another illustrative embodiment of a portion of a centroid calculator in accordance with the principles of the invention; and

FIGS. 19 and 20 show other illustrative embodiments in accordance with the principles of the invention.

### DETAILED DESCRIPTION

Other than the inventive concept, the elements shown in the figures are well known and will not be described in detail. Also, familiarity with television broadcasting and receivers is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC) is assumed. Likewise, other than the inventive concept, transmission concepts such as eight-level vestigial sideband (8-VSB), Quadrature Amplitude Modulation (QAM), and receiver components such as a radio-frequency (RF) front-end, or receiver section, such as a low noise block, tuners, demodulators, correlators, leak integrators and squarers is assumed. Similarly, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

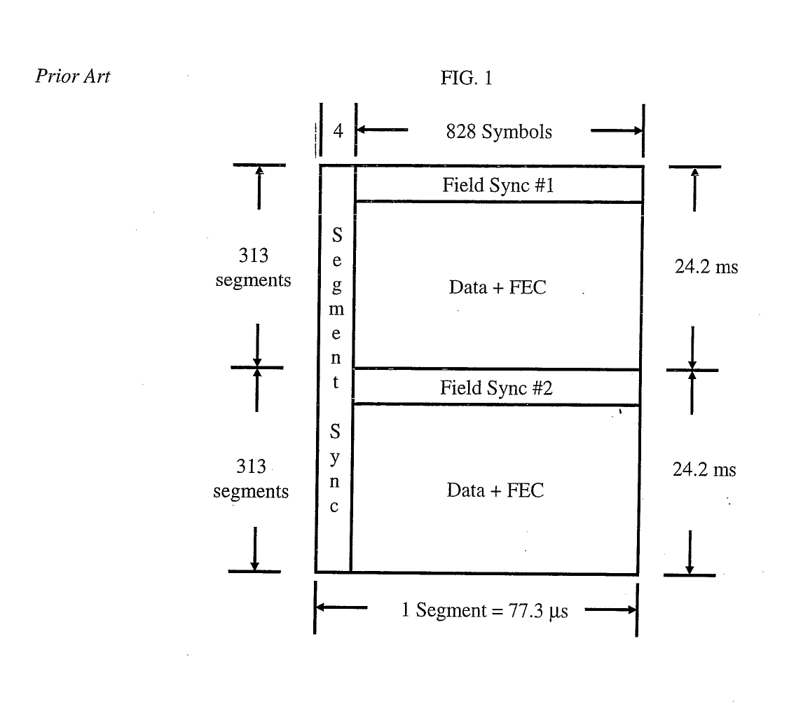

In modern digital communication systems like the ATSC-DTV (Advanced Television Systems Committee—Digital Television) system noted earlier, the use of correlators for signal detection is a common practice. In the ATSC-DTV system, the modulation system is Vestigial Sideband (VSB) with 8 levels (±1, ±3, ±5, ±7) and there are two types of synchronization, or training, signals: the segment sync signal and the field sync signal. This is illustrated in FIG. 1, which shows that the VSB digital symbol sequence in the ATSC-DTV system is structured in data segments and data fields.

Turning first to a data segment, this is composed of 832 symbols of which the first 4 symbols constitute the segment sync signal. The segment sync signal is a two-level (binary) 4-symbol uncoded pattern that appears in the data symbol sequence every 832 symbols. The binary representation is (1 0 0 1) and the symbol representation is (+5−5−5+5).

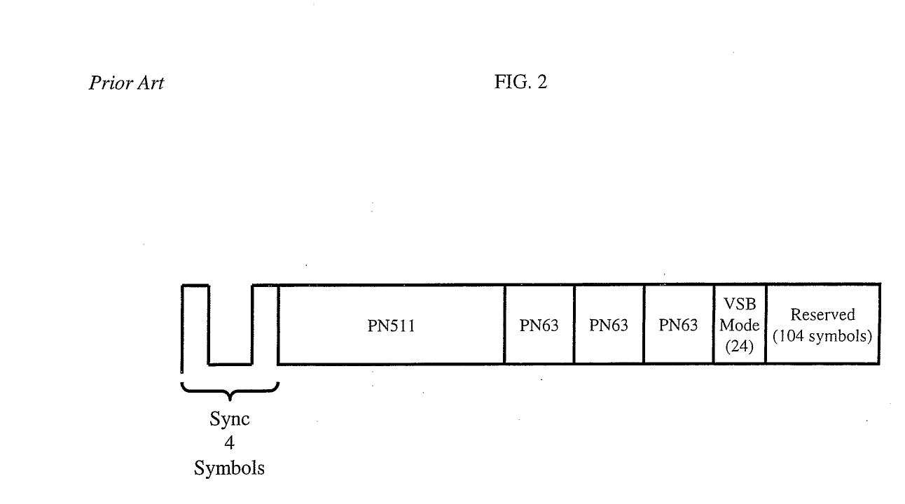

In comparison, a data field is composed of 313 data segments of which the first segment constitutes the field sync signal. The field sync signal is also a two-level (binary) uncoded pattern composed of several Pseudo Noise (PN) sequences and reserved patterns, as shown in FIG. 2. As known in the art, the training portion of the field sync signal consists of the PN sequences (PN511 and PN63). The PN511 is a pseudo-random sequence generated by a shift-register defined by the polynomial X⁹+X⁷+X⁶+X⁴+X³+X+1 and a pre-load value of (010000000). The PN63 is a pseudo-random sequence generated by a shift-register defined by the polynomial X⁶+X+1 and a pre-load value of (100111). The PN63 is repeated three times with the middle PN63 being inverted on every other field sync.

Since the segment sync data pattern and field sync data pattern are known, various algorithms used in the synchronization, timing recovery and equalization elements of an ATSC-DTV receiver use this information to improve receiver performance by correlating the received ATSC-DTV signal with the segment sync pattern and/or the field sync pattern. In particular, it is conventional practice to apply real correlation to the received ATSC-DTV signal. In other words, the in-phase component of the received ATSC-DTV signal is correlated against the segment sync data pattern and/or the frame sync data pattern in order to detect the presence of the respective sync pattern. A real correlator (also typically referred to as just a “correlator”) is used because a digital VSB modulated signal has discrete values, while the quadrature component has a range of non-discrete values. For example, in an ATSC-DTV signal, the VSB in-phase component has 8 levels (±1, ±3, ±5, ±7) but the quadrature component is non-discrete in a range that actually extends beyond ±7 and is a function of the Hilbert transform and the input data.

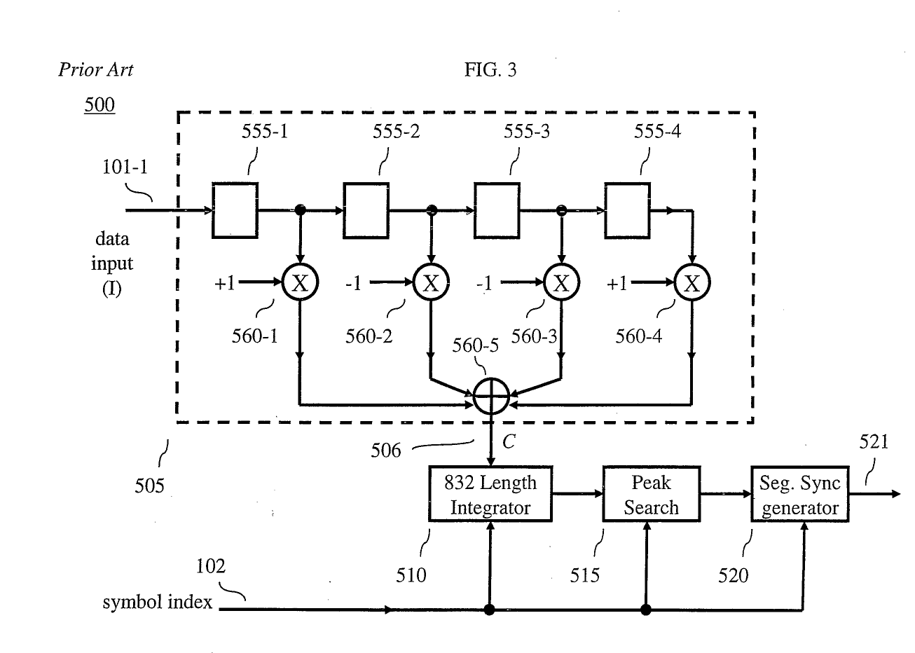

A block diagram of a prior art correlator in the context of a ATSC-DTV segment sync detector 500 is shown in FIG. 3. ATSC-DTV segment sync detector 500 comprises correlator 505, 832 length integrator 510 (hereafter simply integrator 510), peak search element 515 and segment (seg.) sync generator 520. In particular, a received ATSC signal is demodulated by a demodulator (not shown), which provides a demodulated signal 101. The in-phase (I) component, 101-1, is applied to correlator 505, which correlates signal 101-1 against the known ATSC-DTV segment sync pattern for detection of the segments sync signal in the received ATSC-DTV signal. As noted above, the ATSC-DTV segment sync signal is a two-level (binary) 4-symbol uncoded pattern that appears in the data symbol sequence every 832 symbols. The binary representation is (1 0 0 1) and the symbol representation is (+5−5−5+5). Correlator 105 comprises a four tap delay line 555 as represented by taps 555-1, 555-2, 555-3 and 555-4, a corresponding set of multipliers (560) as represented by multipliers 560-1, 560-2, 560-3 and 560-4, one for each tap, respectively, and an adder, 560-5. For simplicity, appropriate clocking signals are not shown in FIG. 3. As such, correlator 505 delays the in-phase data input signal 101-1 by delay line 555 and, as can be observed from FIG. 3, multiplies (via multipliers 560) the appropriate tap outputs by the pattern (+1−1−1+1), which is a scaled version of the segment sync pattern.

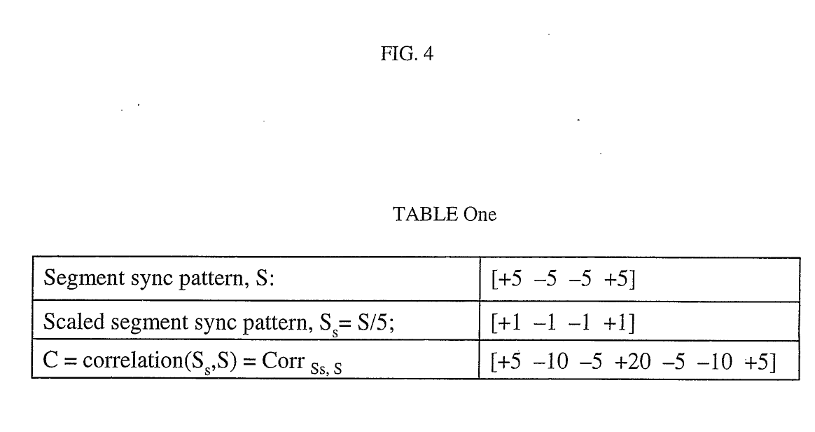

Referring briefly to FIG. 4, Table One shows the segment sync pattern (S), the scaled version of segment sync pattern (Sₛ), and the result of the correlation (C) by correlator 505 of FIG. 3 when a segment sync pattern in data signal 101-1 correlates with Sₛ. The formula for the correlation of real vectors A and B of length N is a vector of length 2*N−1 defined by:

$${Corr}_{A , B} ( m ) = \{ \begin{matrix}{\sum }_{n = 0}^{N - m - 1} {A}_{n} * {B}_{n + m} , 0 \leq m < N \\ {\sum }_{n = 0}^{N + m - 1} {B}_{n} * {A}_{n - m} , - N < m < 0\end{matrix} \qquad ( 1 )$$

In Table One, the center value of +20 in C corresponds to the peak position. It should be noted that the −10, +5 and −5 values of C in Table One correspond to partial correlation values when both patterns are offset in time from each other and therefore do not fully match. However, these partial values do not exceed the value in the peak position.

Returning to FIG. 3, adder 560-5 provides C, via output signal 506, to integrator 510. The latter accumulates output signal 506 from correlator 505 with a 832 symbol-length integrator, i.e., the size of a VSB data segment. The symbol index 102 is a virtual index that may be originally reset at zero and is incremented by one for every new input data symbol, repeating a pattern from 0 to 831. Symbol index 102 is provided, e.g., by a processor (not shown). Since, as known in the art, the received VSB data is random, the integrator values at data symbol positions will tend to be averaged toward zero. However, since the four segment symbols repeat every 832 symbols, the integrator value at a segment sync location will grow proportionally to the signal strength. If the channel impulse response presents multipath or ghosts, the segment sync symbols will appear at those multipath delay positions as well. As a result, the integrator values at the multipath delay positions will also grow proportionally to the ghost amplitude. However, since a ghost is by definition smaller than the main path, a peak search of the 832 symbol positions of integrator 510 will yield the correct segment sync position at the largest integrator value. In this regard, peak search element 515 performs a peak search over the 832 symbol positions of integrator 510 for the above-noted peak position. The output signal from peak search element 515 corresponds to the peak value among the 832 values stored in integrator 510. Seg. Sync generator 520 is responsive to the peak value and the associated symbol index value (via signal 102) and creates a segment sync flag 521. For example, segment sync flag 521 is a binary signal that has a value of “1” during the four symbols of the segment sync signal and value of “0” otherwise. Alternately, the segment sync flag can be set to a value of “1” during the first symbol of a segment sync signal and set to a value of “0” otherwise. (The use of a segment sync flag is not relevant to the inventive concept and, as such, is not described herein.)

In view of the above, any sync signal or sync pattern may be detected by the same principles as described above in the context of segment sync detector 500. For example, a field sync detection system follows the same principles as described above and will not be discussed herein. Of note are the following differences from a segment sync detector: (a) the correlator searches signal 101-1 for the known PN sequences present in the field sync pattern; (b) the length of the integrator is related to the symbol length of a field, instead of a segment; and (c) the field sync flag (now provided by a field sync detector) may have the duration of a field sync, or may indicate the first symbol of a field sync.

We have realized that use of a real correlator in a receiver may limit receiver performance since the real correlator only uses the in-phase component of the received signal. Therefore, and in accordance with the principles of the invention, a receiver comprises a demodulator for providing a demodulated signal and a complex correlator for correlating the demodulated signal against a data pattern.

In particular, in a VSB modulated signal, the in-phase (I) and the quadrature (Q) components are related to each other by the Hilbert transform, that is, Q is the Hilbert transform of I. The Hilbert transform is a linear operation that performs a 90° phase rotation of a signal. We have realized that since the 1 and Q components of the signal are correlated but the I and Q noise components of an additive white Gaussian noise (AWGN) process are uncorrelated, the correlator performance—and therefore receiver performance—can be improved by processing both the I and Q components. Thus, and in accordance with the inventive concept, a receiver includes a complex correlator to search for a training signal or training pattern in the Q component as well as in the I component of a received signal.

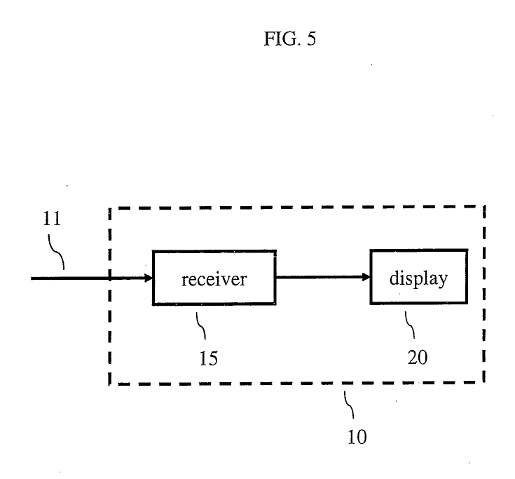

A high-level block diagram of an illustrative television set 10 in accordance with the principles of the invention is shown in FIG. 5. Television (TV) set 10 includes a receiver, 15 and a display 20. Illustratively, receiver 15 is an ATSC-compatible receiver. It should be noted that receiver 15 may also be NTSC (National Television Systems Committee)-compatible, i.e., have an NTSC mode of operation and an ATSC mode of operation such that TV set 10 is capable of displaying video content from an NTSC broadcast or an ATSC broadcast. For simplicity in describing the inventive concept, only the ATSC mode of operation is described herein. Receiver 15 receives a broadcast signal 11 (e.g., via an antenna (not shown)) for processing to recover therefrom, e.g., an HDTV (high definition TV) video signal for application to display 20 for viewing video content thereon. In accordance with the principles of the invention, receiver 15 includes one, or more, complex correlators. For illustration purposes only, the inventive concept is described in the context of a segment sync detector. However, the inventive concept is not so limited.

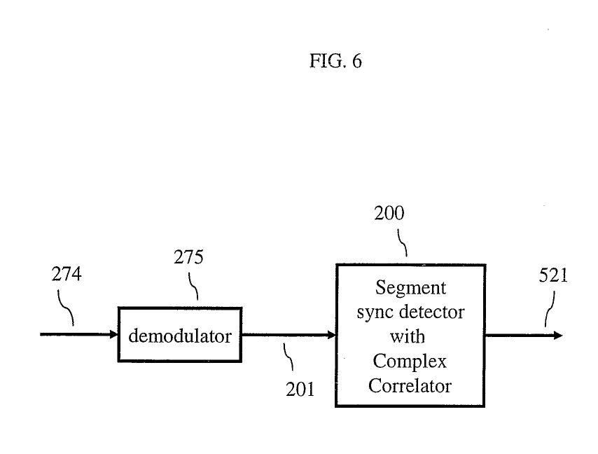

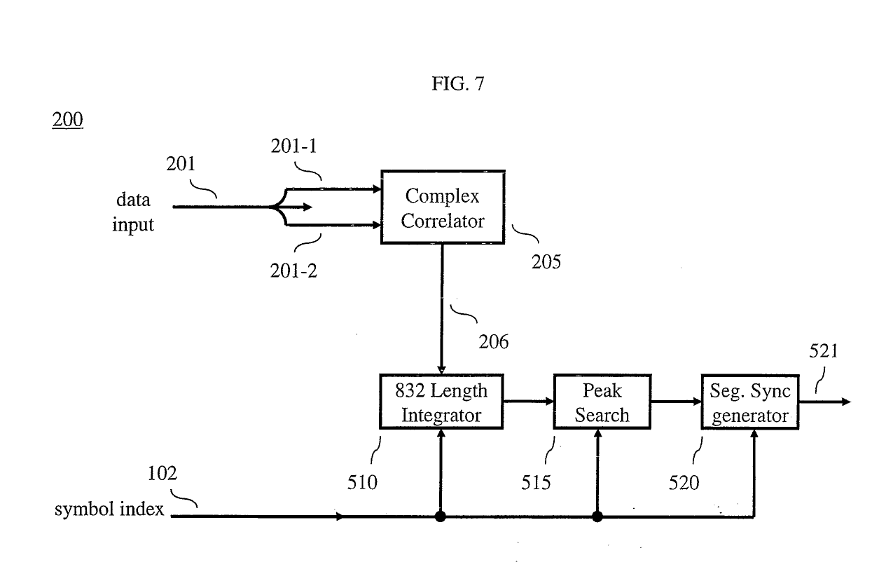

An illustrative block diagram of the relevant portion of receiver 15 is shown in FIG. 6. A demodulator 275 receives a signal 274 that is centered at an IF frequency (F_{IF}) and has a bandwidth equal to 6 MHz (millions of hertz). Demodulator 275 provides a demodulated received ATSC-DTV signal 201 to a segment sync detector with a complex correlator (segment sync detector) 200, which, and in accordance with the principles of the invention, performs a complex correlation on both the I and Q components of demodulated signal 201 for use in providing a segment sync flag 521. In particular, as shown in FIG. 7 and as described further below, the complex correlator of segment sync detector 200 correlates an in-phase component, 201-1, of demodulated signal 201 against the ATSC segment sync pattern and correlates a quadrature component, 201-2, of demodulated signal 201 against a Hilbert transform of the ATSC segment sync pattern. (It should be noted that other processing blocks of receiver 15 not relevant to the inventive concept are not shown herein, e.g., an RF front end for providing signal 274, etc.)

Turning now to FIG. 7, an illustrative block diagram of segment sync detector 200 in accordance with the principles of the invention is shown. As can be observed from FIG. 7, segment sync detector 200 is similar to segment sync detector 500 of FIG. 3 except a complex correlator 205 operates on both the in-phase (I) component, 201-1, and on the quadrature (Q) component, 201-2, of demodulated signal 201 to search for the segment sync pattern.

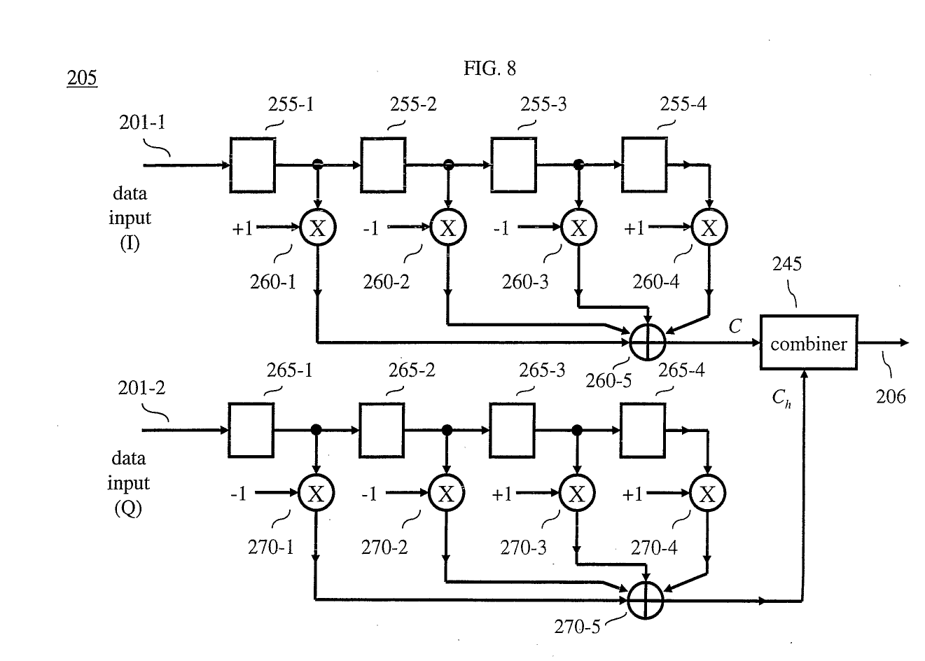

Referring now to FIG. 8, an illustrative block diagram of complex correlator 205 is shown. Correlator 205 comprises an in-phase processing section, a quadrature processing section and a combiner 245. The in-phase processing section is a four tap delay line 255 as represented by taps 255-1, 255-2, 255-3 and 255-4, a corresponding set of multipliers (260) as represented by multipliers 260-1, 260-2, 260-3 and 260-4, one for each tap, respectively, and an adder 260-5. For simplicity, appropriate clocking signals are not shown in FIG. 8. As such, this portion of correlator 205 delays the in-phase component, 201-1, of demodulated signal 201, by delay line 255 and, as can be observed from FIG. 8, multiplies (via multipliers 260) the appropriate tap outputs by the pattern (+1−1−1+1), which is the earlier-described scaled version of the segment sync pattern. Finally, it adds all four multiplier outputs together (via adder 260-5). Turning now to the quadrature processing section, this section is a four tap delay line 265 as represented by taps 265-1, 265-2, 265-3 and 265-4, a corresponding set of multipliers (270) as represented by multipliers 270-1, 270-2, 270-3 and 270-4, one for each tap, respectively, and an adder 270-5. Again, for simplicity, appropriate clocking signals are not shown in FIG. 8. The quadrature portion of correlator 205 delays the quadrature component, 201-2, of demodulated signal 201, by delay line 265 and, as can be observed from FIG. 8, multiplies (via multipliers 270) the appropriate tap outputs by the pattern (+1+1−1−1), which, as described below, is a scaled version of a Hilbert transform of the segment sync pattern (this is also referred to herein as the quadrature component of the segment sync pattern). Finally, it adds all four multiplier outputs together (via adder 270-5).

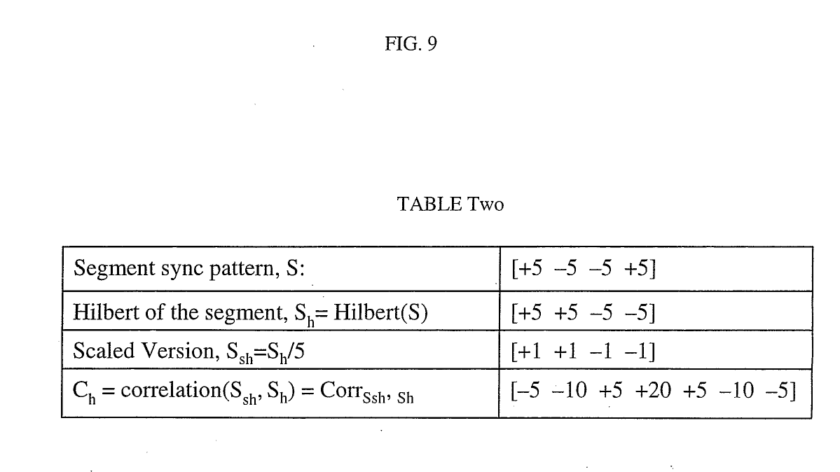

Referring briefly to FIG. 9, Table Two shows, in accordance with the principles of the invention, the additional patterns related to the Q component of the received signal. In particular. Table Two shows the Filbert transform of the segment sync pattern, Sₗₜ, a corresponding scaled version, Sₛₕ, and the correlation between Sₗₜ and Sₛₕ, i.e., Cₗₜ, according to equation (1) (above). In accordance with the principles of the invention, the resulting similarities between C of Table One (shown in FIG. 4) and Ch of Table Two are now exploited by use of the complex correlator 205 of FIG. 8.

Returning now to FIG. 8, combiner 245 of complex correlator 205 combines C and Cₕ to create C_{comb}. Illustratively, C_{comb}=C+Cₕ. In this case, C_{comb}=(0−20 0+40 0−20 0). In accordance with the principles of the invention, it should be noted that some of the partial correlation values disappear but the peak value doubles, showing an increased correlation. The output signal 206, C_{comb}, is applied to integrator 510 of FIG. 7. The remainder of the elements of segment sync detector 200 shown in FIG. 7 function as described previously to provide a segment sync flag 521.

It should be noted that other variations in accordance with the principles of the invention are possible. For example, combiner 245 can function in accordance with the following equation, C_{comb}=|C|+|Cₕ|, where |x| represents the absolute value of x or the square of x. In this case, C_{comb}=(+10+20+10+40+10+20+10) when using the absolute value. None of the partial correlation values disappear, instead increasing in magnitude, and the peak value doubles, showing an increased correlation.

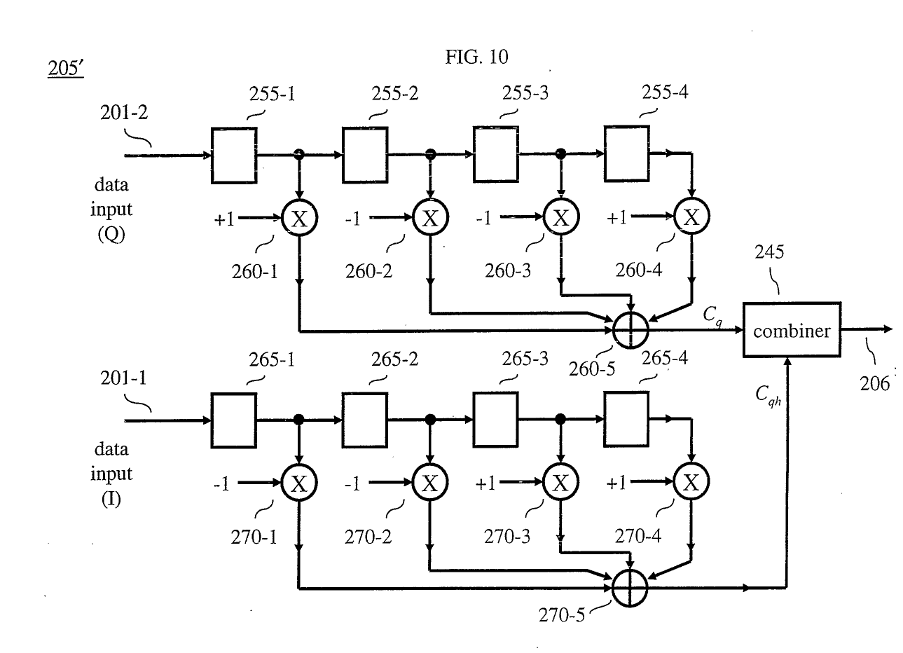

Another embodiment in accordance with the principles of the invention is shown in FIG. 10. Complex correlator 205′ is similar to complex correlator 205 of FIG. 8 except that the I and Q input signals are exchanged. This is also referred to herein as a quadrature complex correlator. As can be observed from FIG. 10, the Q component, 201-2, is applied to the in-phase processing section of complex correlator 205′ and the I component, 201-1, is applied to the quadrature processing section of complex correlator 205′. In this regard, the in-phase processing section provides the correlation between Sₛ and Sₗₜ, i.e., C_{q}, and the quadrature processing section provides the correlation between Sₛₕ and S, i.e., C_{qh}.

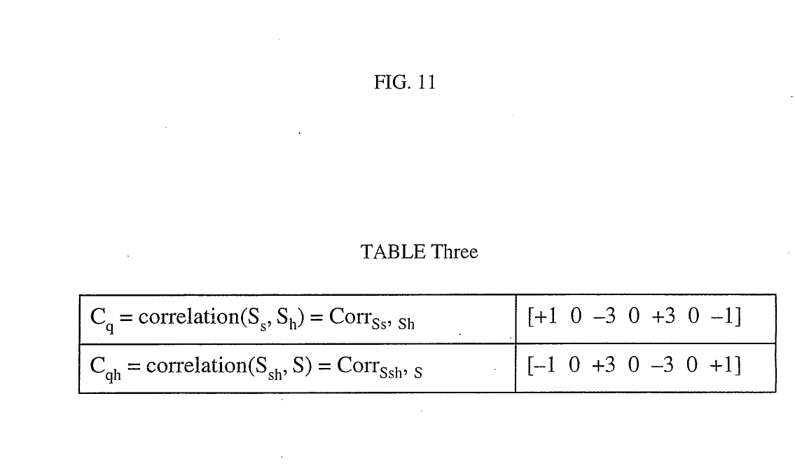

Referring briefly to FIG. 11, Table Three shows, in accordance with the principles of the invention, the additional patterns C_{q} and C_{qh} related to the embodiment shown in FIG. 10. Since C_{q} and C_{qh} are the inverse of each other, combiner 245 of correlator 205′ performs a subtraction, i.e., C_{comb}=C_{q}−C_{qh}. As such, C_{comb}=(+2 0−6 0+6 0−2).

In another embodiment in accordance with the principles of the invention, combiner 245 of correlator 205′ functions in accordance with the following equation, C_{comb}=|C_{q}|+|C_{qh}|, where |x| represents the absolute value of x or the square of x. In this case, C_{comb}=(+2 0+6 0+6 0+2) when using the absolute value.

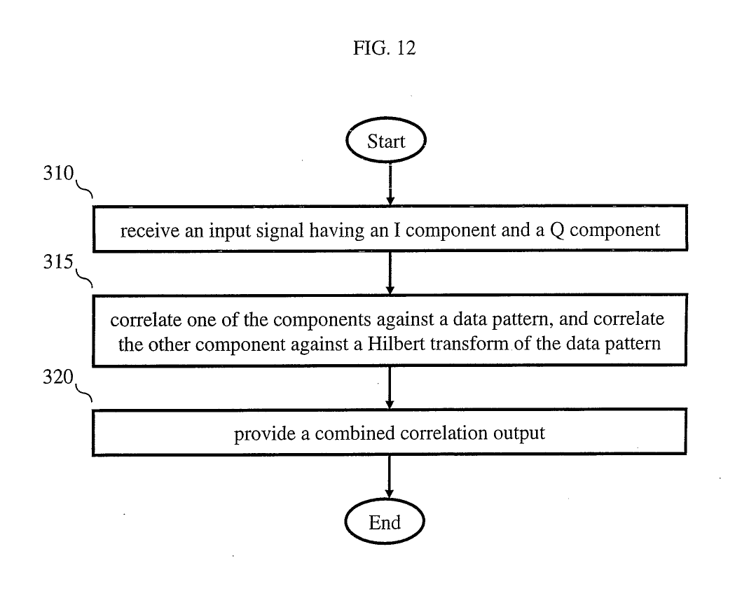

An illustrative flow chart in accordance with the principles of the invention for use in a receiver is shown in FIG. 12. In step 310, the receiver receives an input signal having an in-phase (I) component and a quadrature (Q) component. In step 315, the receiver correlates one of the components against a data pattern and the other of the components against a Hilbert transform of the data pattern. Examples of step 315 were provided earlier in the context of an ATSC segment sync signal as the data pattern. For example, the I component can be correlated against the segment sync signal, while the Q component can be correlated against the Hilbert transform of the segment sync signal as illustrated in correlator 205 of FIG. 8. Conversely, the I component can be correlated against the Hilbert transform of the segment sync signal, while the Q component is correlated against the segment sync signal as illustrated in correlator 205′ of FIG. 10. Finally, in step 320, the combined correlation signal, C_{comb}, is provided as the output signal.

The inventive concept has applications to other processing elements of a receiver. For example, application of the inventive concept to a centroid calculator with a complex input signal (i.e., with in-phase and quadrature components) results in better estimation of the channel virtual center due to the better performance of the complex correlator. In addition, application of the inventive concept and non-leak integrators to a centroid calculator results in the centroid calculator being immune to symbol timing phase ambiguity in the demodulated signal.

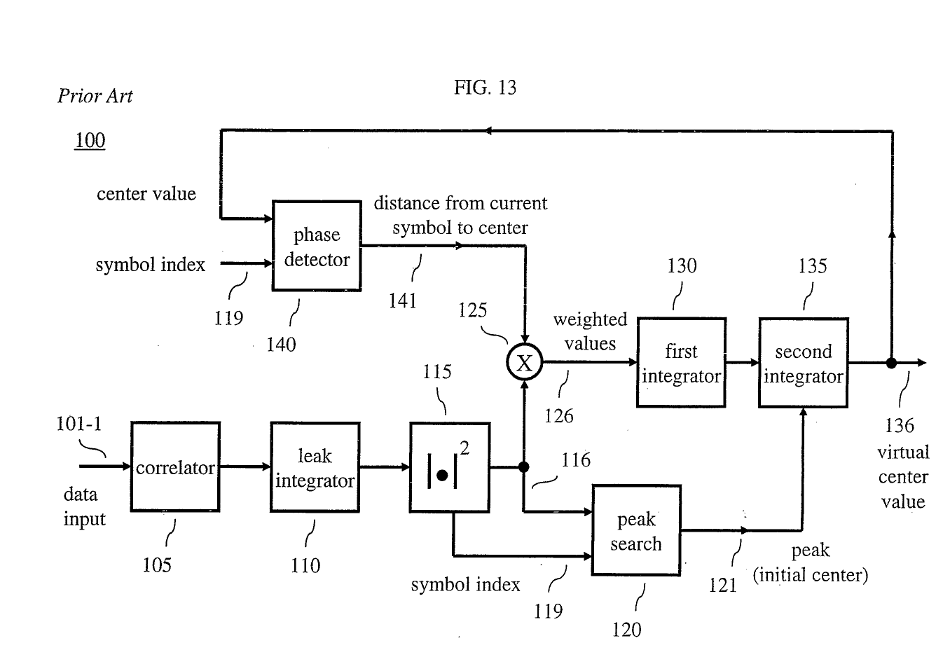

Before describing the inventive concept, a block diagram of a prior art centroid calculator 100 is shown in FIG. 13 for use in an ATSC-DTV system. Centroid calculator 100 comprises correlator 105, leak integrator 110, squarer 115, peak search element 120, multiplier 125, first integrator 130, second integrator 135 and phase detector 140. Centroid calculator 100 is based on the segment sync signal, one sample-per-symbol and a data input signal 101 comprising only the in-phase (real) component (101-1). The data input signal 101 represents a demodulated received ATSC-DTV signal provided by a demodulator (not shown).

The data input signal 101-1 is applied to correlator 105 for detection of the segment sync signal (or pattern) therein. As noted before, the segment sync signal has a repetitive pattern and the distance between two adjacent segment sync signals is rather large (832 symbols). As such, the segment sync signal can be used to estimate the channel impulse response, which in turn is used to estimate the channel virtual center or centroid. Correlator 105 correlates the in-phase component, 101-1, of data input signal 101, against the characteristic of the ATSC-DTV segment sync, that is, [1 0 0 1] in binary representation, or [+5−5−5+5] in VSB symbol representation. The output signal from correlator 105 is then applied to leak integrator 110. The latter has a length of 832 symbols, which equals the number of symbols in one segment. Since the VSB data is random, the integrator values at data symbol positions will be averaged towards zero. However, since the four segment sync symbols repeat every 832 symbols, the integrator value at a segment sync location will grow proportionally to the signal strength. If the channel impulse response presents multipath or ghosts, the segment sync symbols will appear at those multipath delay positions. As a result, the integrator values at the multipath delay positions will also grow proportionally to the ghost amplitude. The leak integrator is such that, after a peak search is performed, it subtracts a constant value every time the integrator adds a new number. This is done to avoid hardware overflow. The 832 leak integrator values are squared by squarer 115. The resultant output signal, or correlator signal 116, is sent to peak search element 120 and multiplier 125. (It should be noted that instead of squaring, element 115 may provide the absolute value of its input signal.)

As each leak integrator value (correlator signal 116) is applied to peak search element 120, the corresponding symbol index value (symbol index 119) is also applied to peak search element 120. The symbol index 119 is a virtual index that may be originally reset at zero and is incremented by one for every new leak integrator value, repeating a pattern from 0 to 831. Peak search element 120 performs a peak search over the 832 squared integrator values (correlator signal 116) and provides peak signal 121, which corresponds to the symbol index associated with the maximum value among the 832 squared integrator values. The peak signal 121 is used as the initial center of the channel and is applied to second integrator 135 (described below).

The leak integrator values (correlator signal 116) are also weighted by the relative distance from the current symbol index to the initial center and a weighted center position is then determined by a feedback loop, or centroid calculation loop. The centroid calculation loop comprises phase detector 140, multiplier 125, first integrator 130 and second integrator 135. This feedback loop starts after the peak search is performed and second integrator 135 is initialized with the initial center or peak value. Phase detector 140 calculates the distance (signal 141) between the current symbol index (symbol index 119) and the virtual center value 136. The weighted values 126 are calculated via multiplier 125 and are fed to first integrator 130, which accumulates the weighted values for every group of 832 symbols. As noted above, second integrator 135 is initially set to the peak value and then proceeds to accumulate the output of first integrator 130 to create the virtual center value, or centroid, 136. All integrators in FIG. 13 have implicit scaling factors.

Once the virtual center value 136 is determined, the VSB reference signals, such as the segment sync and the frame sync signal, are locally re-generated (not shown) in the receiver to line up at the virtual center. As a result, taps will grow in the equalizer to equalize the channel such that the equalized data output will be lined up at the virtual center.

Extensions of the system described above with respect to FIG. 13 to a complex data input signal (in-phase and quadrature components), two samples per symbol or to a frame sync based design are easily derived from FIG. 13.

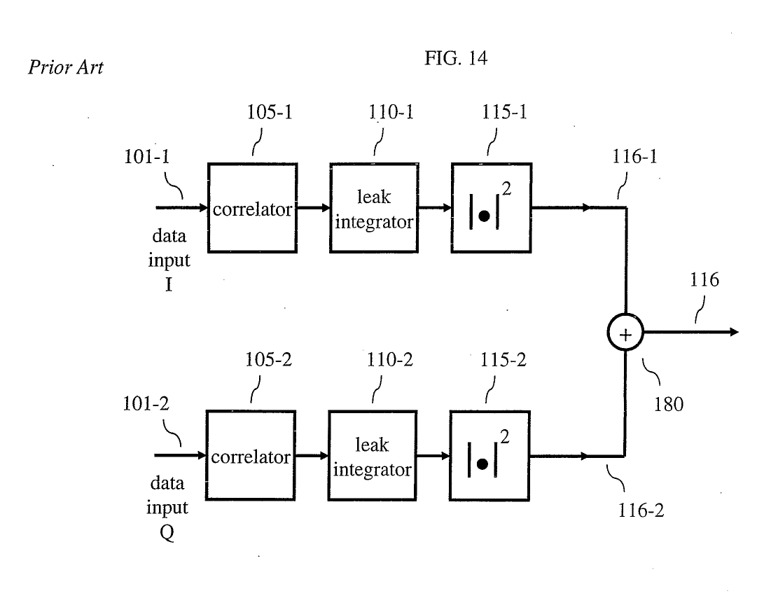

For example, if the data input signal is complex, the centroid calculator (now also referred to as a “complex centroid calculator”) separately processes the in-phase (I) and quadrature (Q) components of the input data signal as shown in FIG. 14. In particular, the in-phase component (101-1) of the input data signal is processed via correlator 105-1, leak integrator 110-1 and squarer 115-1; while the quadrature component (101-2) of the input data signal is processed via correlator 105-2, leak integrator 110-2 and squarer 115-2. Each of these elements function in a similar fashion to those described above in FIG. 13. Although not shown in the figure, the symbol index can be generated from either squarer element. The output signals from each squarer (115-1 and 115-2) are added together via adder 180 to provide correlator signal 116 and the remainder of the processing is the same as described above with respect to FIG. 13.

With respect to a two-sample-per-symbol centroid calculator, T/2 spacing is illustratively used (where T corresponds to the symbol interval). For example, the segment sync detector has T/2 spaced values that match with a T/2 spaced segment sync characteristic, the leak integrators are 2×832 long and the symbol index follows the pattern 0, 0, 1, 1, 2, 2, . . . , 831, 831, instead of 0, 1, 2, . . . , 831.

Finally, for a centroid calculator based on the frame sync signal, the following should be noted. Since the frame/field sync signal is composed of 832 symbols and arrives every 313 segments this is longer than any practical multipath spread in a channel, hence, here is no problem in determining the position of any multipath signals. An asynchronous N511 correlator may be used to measure the channel impulse response (if using the PN511 lone, out of the 832 frame sync symbols), as opposed to the segment sync detector in FIG. 13. (PN511 is a pseudo-random number sequence and described in the earlier-noted ATSC standard.) The additional processing is similar to that described above for FIG. 13 except that the processing is performed for the duration of at least one entire field. The correlation values are sent to the peak search function block to perform a peak search over one field time. The symbol index of this peak value is thus to be used as the initial virtual center point. Once the initial center point is determined, then the correlation results are analyzed only when a correlation output is above a pre-determined threshold and within a certain range before and after the initial virtual center point. For example, +/−500 symbols around the initial center position that the correlation output is above the pre-determined values. The exact range is determined by both the practical channel impulse response length that is expected to be encountered in a real environment and the length of the available equalizer. The remainder of the processing is the same as described earlier for FIG. 13.

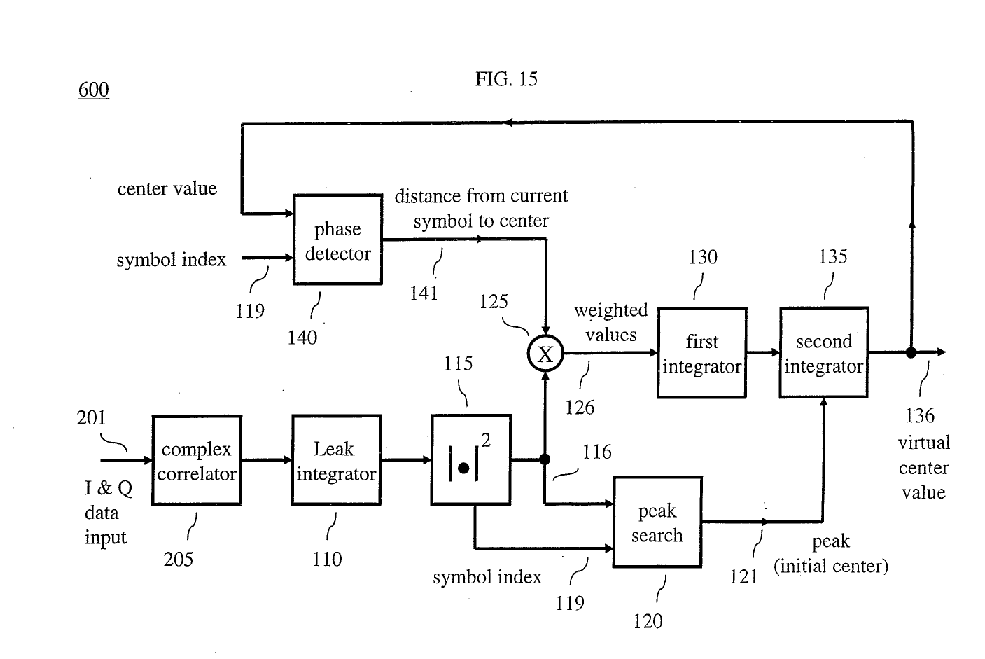

Turning now to FIG. 15, an illustrative embodiment of a centroid calculator 600 in accordance with the principles is shown. Centroid calculator 600 is similar to centroid calculator 100 of FIG. 13, e.g., centroid calculator 600 is based on the segment sync signal and one sample-per-symbol. However, in contrast to centroid calculator 100, centroid calculator 600 includes complex correlator 205. Therefore, centroid calculator 600 requires a complex data input with in-phase (I) and quadrature (Q) components. As described earlier, complex correlator 205 searches for the sync pattern in both the Q component as well as in the I component of the input data signal. It should also be noted that integrator 110 is an 832 symbol leak integrator. A leak integrator subtracts a constant value after the peak search to avoid hardware overflow.

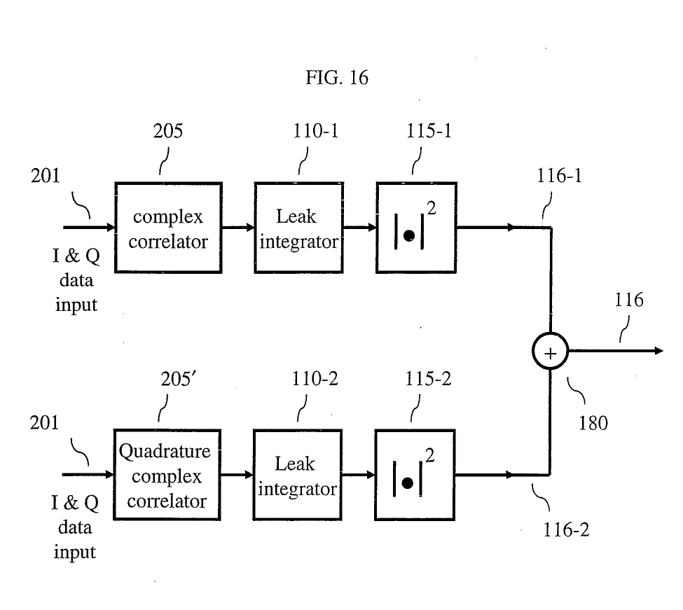

Another illustrative embodiment in accordance with the principles of the invention is shown in FIG. 16. The latter shows the relevant modified portion of centroid calculator 600 that enables centroid calculator 600 to operate in a fashion similar to the above-described complex centroid calculator—but with complex correlators. The arrangement shown in FIG. 16 is similar to the arrangement shown in FIG. 14 except that a complex correlator 205 processes both the I and Q components of demodulated signal 201, while another form of a complex correlator—the above described quadrature complex correlator 205′—also processes both the I and Q components of demodulated signal 201. Otherwise, the operation of the arrangement of FIG. 16 is similar to the above-described operation of the arrangement of FIG. 14.

We have observed that the above-mentioned approaches for determining the channel virtual center do not address the impact of wrong symbol timing phase on the data input to the centroid calculator and consequently, on the centroid estimate. In other words, the above-mentioned approaches do not address the effect of demodulator symbol timing ambiguity in the centroid calculation and do not attempt to correct for this ambiguity. Therefore, and in accordance with the principles of the invention, another embodiment of the invention is proposed of a centroid calculator which includes a complex correlator and is immune to symbol timing ambiguity.

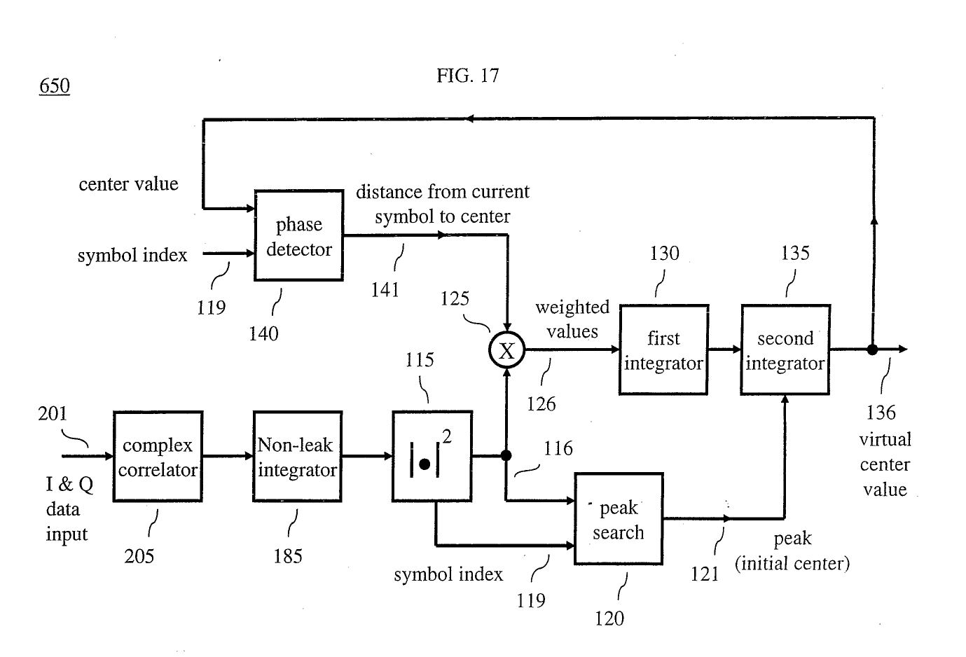

Turning now to FIG. 17, an illustrative embodiment of a centroid calculator 650 in accordance with the principles is shown. Centroid calculator 650 is similar to centroid calculator 600 of FIG. 15, e.g., centroid calculator 650 is based on the segment sync signal and one sample-per-symbol, and includes complex correlator 205. However, in contrast with centroid calculator 600, the integrator is an 832 symbol non-leak integrator 185. A non-leak integrator does not subtract a constant value after the peak search to avoid hardware overflow. Instead, the integrator word-size has to be carefully chosen to permit the calculation without any overflow.

The benefit of using a segment sync detection with a complex correlation followed by a non-leak integrator comes from the observation that regardless of any symbol timing ambiguity in the demodulated signal 201, the centroid calculator will achieve the same peak values as would be achieved by the correct demodulator sample. As a result, centroid calculator 650 is immune to symbol timing ambiguity—a clear advantage over centroid calculator 100 of FIG. 13 as well as centroid calculator 600 of FIG. 15 and FIG. 16, which use a centroid calculator with complex correlators and leak integrators. An additional advantage in the use of centroid calculator 650 is due to the fact that ghost delays will not necessarily be a multiple of the symbol period. Hence, some ghost peaks may be on the fractional samples of the symbol period. Since the use of a complex correlator enables centroid calculator 650 to be independent of the sample, centroid calculator 650 will also perceive the ghost peaks correctly, even if these peaks are associated with fractional samples.

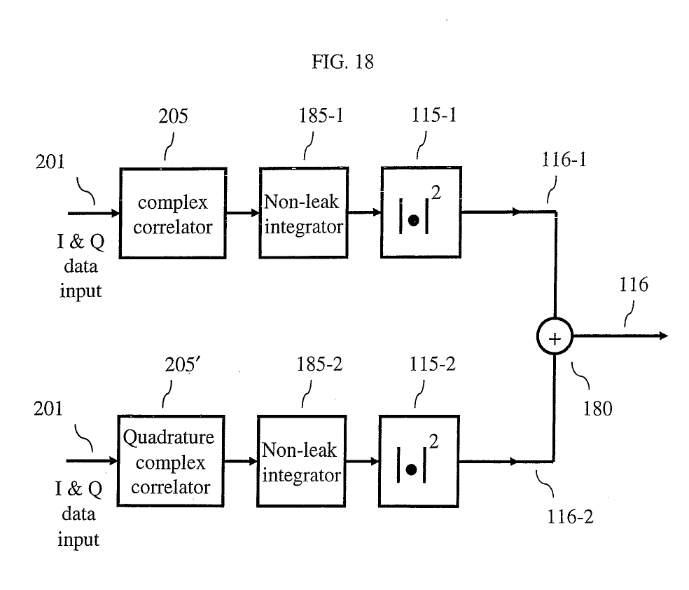

Another illustrative embodiment in accordance with the principles of the invention is shown in FIG. 18. The latter shows the relevant modified portion of centroid calculator 650 that enables centroid calculator 650 to operate in a fashion similar to the above-described complex centroid calculator—but with complex correlators. The arrangement shown in FIG. 18 is similar to the arrangement shown in FIG. 16 except that non-leak integrators 185-1 and 185-2 are also used as shown in FIG. 18. Otherwise, the operation of the arrangement of FIG. 18 is similar to the above-described operation of the arrangement of FIG. 16.

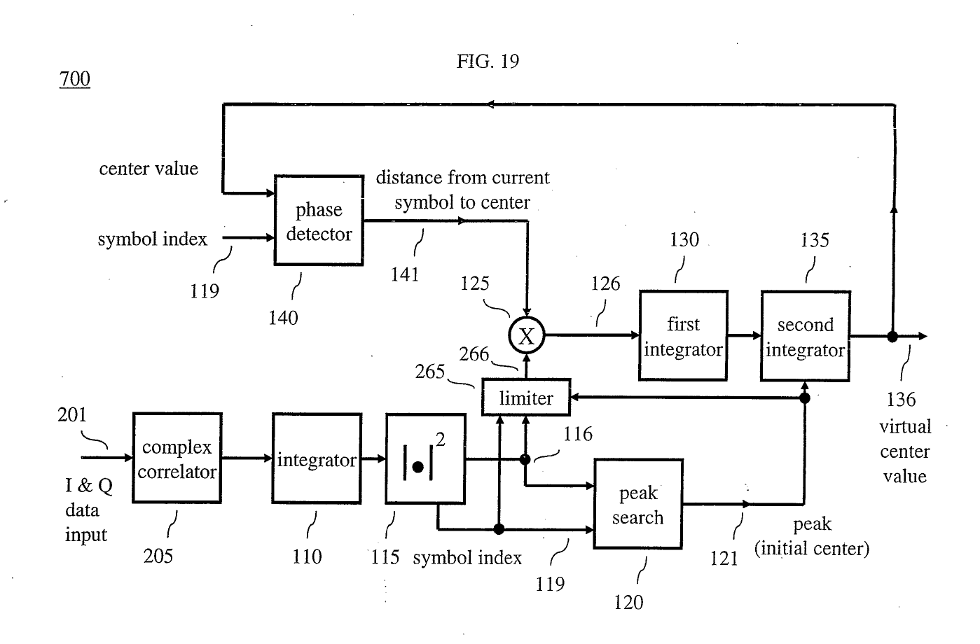

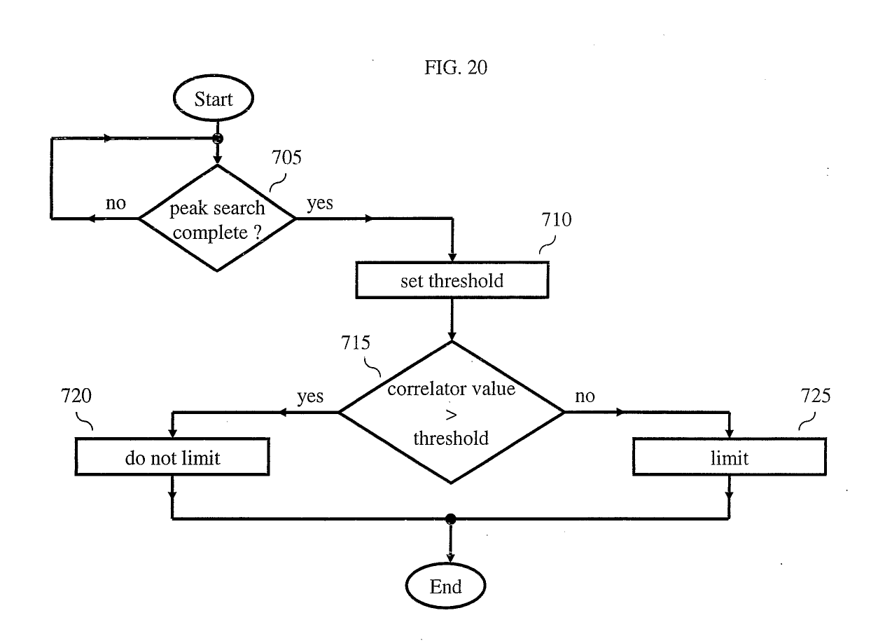

Turning now to FIG. 19, another illustrative embodiment is shown. This embodiment is similar to that shown in FIGS. 15 and 17 except for the inclusion of limiter 265 prior to the weighting operation performed by multiplier 125. The operation of limiter 265 is shown in the illustrative flow chart of FIG. 20. In step 705, limiter 265 waits for completion of the peak search. Once the peak search is complete, limiter 265 sets a threshold value in step 710. Illustratively, the threshold value is set equal to the (peak/K), where the value of K is chosen experimentally. In step 715, limiter 265 determines if the correlator value (116) is greater than the set threshold value. If the correlator value (116) is greater than the set threshold value, then limiter 265 does not limit the correlator value (116) in step 720, i.e., the value of signal 266 is equal to the value of signal 116 in FIG. 19. However, if the correlator value (16) is less than, or equal to, the threshold value, then limiter 265 sets the value of signal 266 equal to an illustrative limiter value, L, in step 725. In this example, L is equal to zero. As a result, in step 725, signal 266 is set equal to zero.

The idea behind limiter 265 is due to the fact that the concept of correlation and the assumption that random data and noise accumulate to zero in integrators assumes large samples, approaching an unbounded sequence size. However, the centroid calculation and consequent integrations happen within a limited amount of time. In fact, since the time for a centroid calculation affects the overall time for a receiver to lock, it is of interest to minimize the centroid calculator time. Therefore, there is a residual noise in the integrators associated with the data input and actual input noise, which is also a function of the centroid calculator operating time. This residual noise is not likely to affect the peak search, except in channels with zero or near zero dB ghosts. But since the weighted values (signal 126 of FIG. 19) are a product of correlated values times the distance from the current symbol to the center, noise in positions far away from the peak value may contribute substantially to the final calculation. As such, by providing a limiter as described above, the residual noise in the correlator integrators can be eliminated, improving the weighted value estimate. This limiter is more efficient if the threshold is a function of the peak value, eliminating excessive limiting in mismatched operation due to possible demodulator carrier phase and symbol timing ambiguities, or Automatic Gain Control (AGC) mismatch.

The disadvantage of the use of a limiter is that in theory, the centroid calculator will be limited to only include ghosts above a certain strength level, since small levels will be disregarded by the limiter 265. However, proper choice of the constant K in step 710 will define a balance between which correlated values are the result of residual noise and which values are actual ghosts. Any ghost strength levels that are below the residual noise levels would not be properly addressed by the centroid calculator either with or without a limiter. As an example, for K=2⁶, the limiter disregards any ghosts that are approximately 18 dB below the main signal.

The addition of a limiter to a centroid calculator applies to all of the embodiments described herein. For example, the centroid calculator arrangement shown in FIG. 13.

All the illustrative embodiments described herein in accordance with the principles of the invention may be extended to perform correlation oil the field sync of the ATSC-DTV system, that is, the correlation is performed on the four component PN sequences that constitute the field sync or a shortened version of them. The correlation, C. and Hilbert correlation, Cₕ, can be identically obtained for the field sync, as in Tables One and Two and equation (1).

In view of the above, all the illustrative embodiments described herein in accordance with the principles of the invention may be extended to perform correlation on any training pattern, or a shortened version of it. The correlations, C, Cₕ, C_{q} and C_{qh}, can be identically obtained for any training pattern, as in Tables One and Two and equation (1).

The foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied on one or more integrated circuits (ICs). Similarly, although shown as separate elements, any or all of the elements of may be implemented in a stored-program-controlled processor, e.g., a digital signal processor, which executes associated software, e.g., corresponding to one or more of the steps shown in, e.g., FIG. 12. Further, although shown as elements bundled within TV set 10, the elements therein may be distributed in different units in any combination thereof. For example, receiver 15 of FIG. 5 may be a part of a device, or box, such as a set-top box that is physically separate from the device, or box, incorporating display 20, etc. Also, it should be noted that although described in the context of terrestrial broadcast, the principles of the invention are applicable to other types of communications systems, e.g., satellite, cable, etc. It is therefore to be understood that numerous modifications may be made to the illustrative embodiments and that other arrangements may be devised without departing from the spirit and scope of the present invention as defined by the appended claims.

1. A receiver, comprising:
a demodulator for providing a demodulated signal; and
a sync detector including a complex correlator for correlating the demodulated signal against an ATSC-DTV (Advanced Television Systems Committee-Digital Television) sync signal for detection thereof.

2. The receiver of claim 1, wherein the sync signal is an ATSC-DTV segment sync signal.

3. The receiver of claim 1, wherein the sync signal is an ATSC-DTV frame sync signal.

4. The receiver of claim 1, wherein the demodulated signal comprises an in-phase component and a quadrature component and the complex correlator comprises:
an in-phase correlator for correlating one of the components of the demodulated signal to the sync signal;
a quadrature correlator for correlating the other one of the components of the demodulated signal to a Hilbert transform of the sync signal; and
a combiner for providing a combined correlation result from the in-phase correlator and the quadrature correlator.

5. The receiver of claim 4, wherein the in-phase correlator correlates the in-phase component of the demodulated signal to the sync signal.

6. The receiver of claim 4, wherein the quadrature correlator correlates the quadrature component of the demodulated signal to the Hilbert transform of the sync signal.

7. The receiver of claim 4, wherein the in-phase correlator correlates the quadrature component of the demodulated signal to the sync signal.

8. The receiver of claim 4, wherein the quadrature correlator correlates the in-phase component of the demodulated signal to the Hilbert transform of the sync signal.

9. A method for use in a receiver, the method comprising the steps of:
providing a signal;
(a) correlating one of the components of the signal to an ATSC-DTV (Advanced Television Systems Committee-Digital Television) sync signal;
(b) correlating the other one of the components of the signal to a Hilbert transform of the sync signal; and
providing a combined correlation result from steps (a) and (b).

10. The method of claim 9, wherein the sync signal is an ATSC DTV segment sync signal.

11. The method of claim 9, wherein the sync signal is an ATSC-DTV frame sync signal.

12. The method of claim 9, wherein step (a) correlates the in-phase component of the signal to the sync signal.

13. The method of claim 9, wherein step (b) correlates the quadrature component of the signal to the Hilbert transform of the sync signal.

14. The method of claim 9, wherein step (a) correlates the quadrature component of the signal to the sync signal.

15. The method of claim 9, wherein step (b) correlates the in-phase component of the signal to the Hilbert transform of the sync signal.
